(19) United States
(12) Patent Application Publication
(10) Pub. No.: US 2009/0080749 A1
(43) Pub. Date: Mar. 26, 2009

(54) COMBINING MAGNETIC RESONANCE IMAGES

(75) Inventors: Cornelis Pieter Visser, Best (NL); Marcel Breeuwer, Best (NL)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N. V., Eindhoven (NL)

(21) Appl. No.: 12/293,367

(22) PCT Filed: Mar. 16, 2007
(86) PCT No.: PCT/IB2007/050903

§ 371 Date: Sep. 17, 2008

(30) Foreign Application Priority Data
Mar. 17, 2006 (EP) 06111334.6

(51) Int. Cl. G06K 9/00

(52) U.S. Cl. 382/131

(57) ABSTRACT

The invention relates to a method of combining magnetic resonance (MR) images to form a combined image, to a device for implementing such a method, and to a computer program comprising instructions for performing such a method when the computer program is run on a computer. Large transitions in pixel values in such combined images could make visual interpretation of the combined image difficult. A method of combining MR images to form a combined image that is easier to interpret visually is therefore desirable. Accordingly, a method of forming a combined image is disclosed, wherein pixel intensity values of at least one of the images is modified based on an interpolation operation, and the two MR images are suitably merged to form a combined image.

This invention relates to processing of magnetic resonance (MR) images, and more particularly to combining multiple MR images to form a combined image.

US 2005/0129299 A1 discusses an implementation of a method of combining radiographic images having an overlap section. Such a method, when applied to MR images, may still show large transitions in pixel values, which could make visual interpretation of the combined image difficult. Thus, a method of combining MR images to form a combined image that is easier to interpret visually is desirable.

Accordingly, in a method disclosed herein of combining duplicative portions of MR images to form a combined image, a first value is computed based on pixel intensities in a first region of a first MR image and pixel intensities in a second region of a second MR image. A second value is computed based on pixel intensities in a third region of the second MR image. Intermediate values may be computed by interpolating between the first and the second values. Pixel intensity values of the second MR image are then modified based on the interpolation, to yield a modified second image. A duplex combined image is formed by merging the first image and the modified second image such that the first and second regions overlap each other. Duplicative portions of MR images are portions of MR images that depict substantially the same portion of the subject's anatomy. It may be noted that the disclosed method is applicable to both two-dimensional as well as three-dimensional MR image datasets. Hence, the word “image” as used in this document denotes either a two-dimensional image slice or a three-dimensional image volume, as the case may be.

It is also desirable to have an MR system capable of combining duplicative portions of MR images to form a combined image that is easier to interpret visually.

Accordingly, an MR system disclosed herein includes a computer configured to compute a first value based on pixel intensities in a first region of a first MR image and pixel intensities in a second region of a second MR image. A second value is computed based on pixel intensities in a third region of the second MR image. Intermediate values may be computed by interpolating between the first and the second values. Pixel intensity values of the second MR image are then modified based on the interpolation, to yield a modified second image. A duplex combined image is formed by merging the first image and the modified second image such that the first and second regions overlap each other.

It is also desirable to have a computer program capable of instructing a computer to combine duplicative portions of MR images to form a combined image that is easier to interpret visually, when the computer program is run on the computer.

Accordingly, a computer program disclosed herein includes instructions for computing a first value based on pixel intensities in a first region of a first MR image and pixel intensities in a second region of a second MR image. A second value is computed based on pixel intensities in a third region of the second MR image. Intermediate values may be computed by interpolating between the first and the second values. Pixel intensity values of the second MR image are then modified based on the interpolation, to yield a modified second image. A duplex combined image is formed by merging the first image and the modified second image such that the first and second regions overlap each other.

These and other aspects will be described in detail hereinafter, by way of example, on the basis of the following embodiments, with reference to the accompanying drawings, wherein:

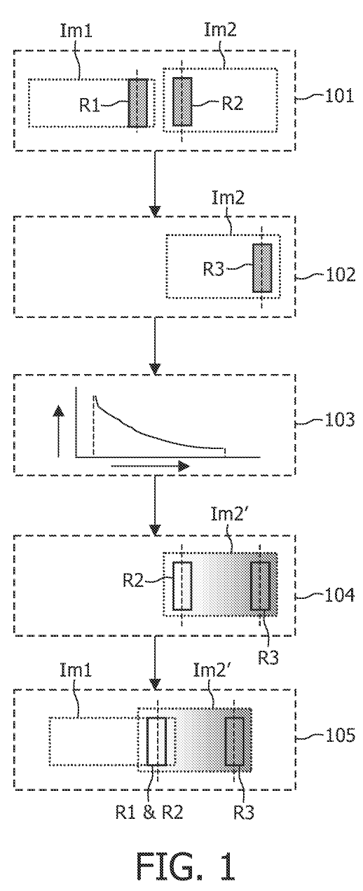

FIG. 1 illustrates a method of combining two MR images with duplicative portions;

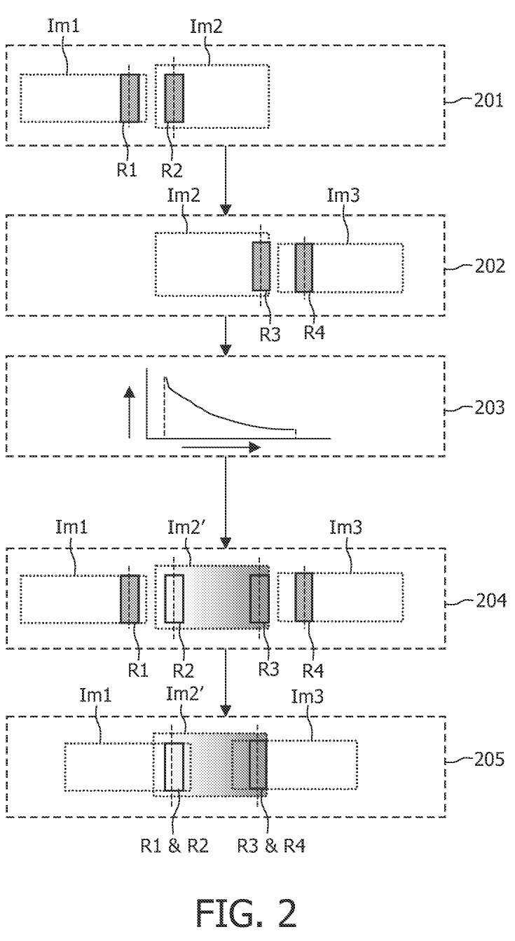

FIG. 2 illustrates a method of combining three MR images with duplicative portions;

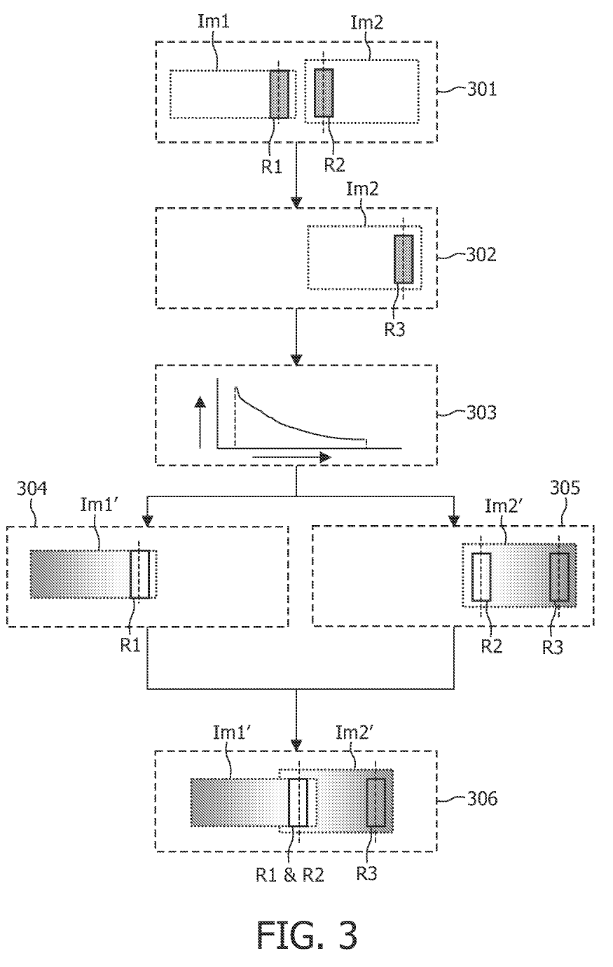

FIG. 3 illustrates another method of combining two MR images with duplicative portions;

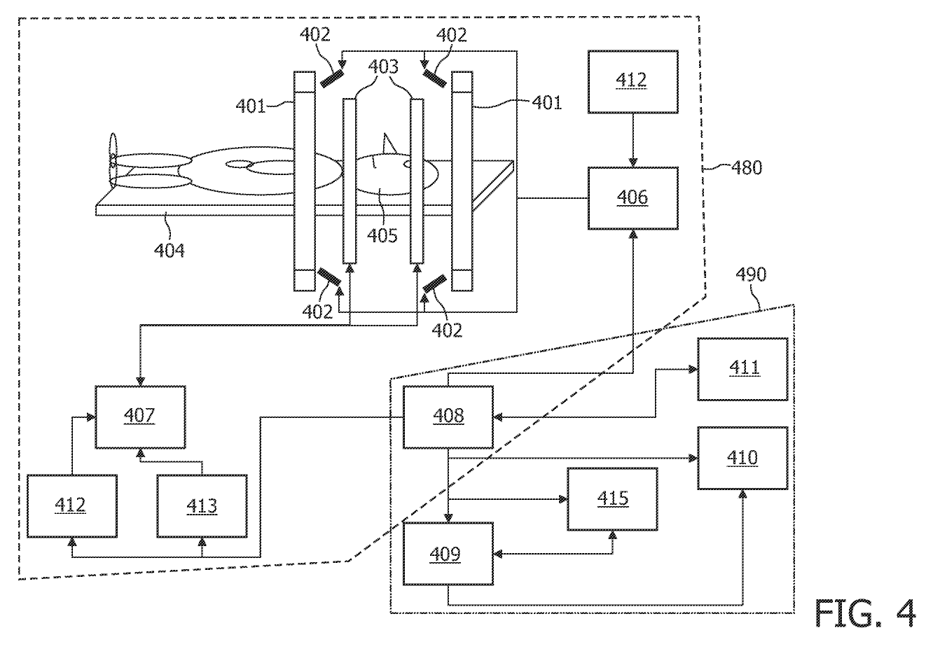

FIG. 4 schematically shows an MR system capable of combining duplicative portions of MR images to form a combined image; and

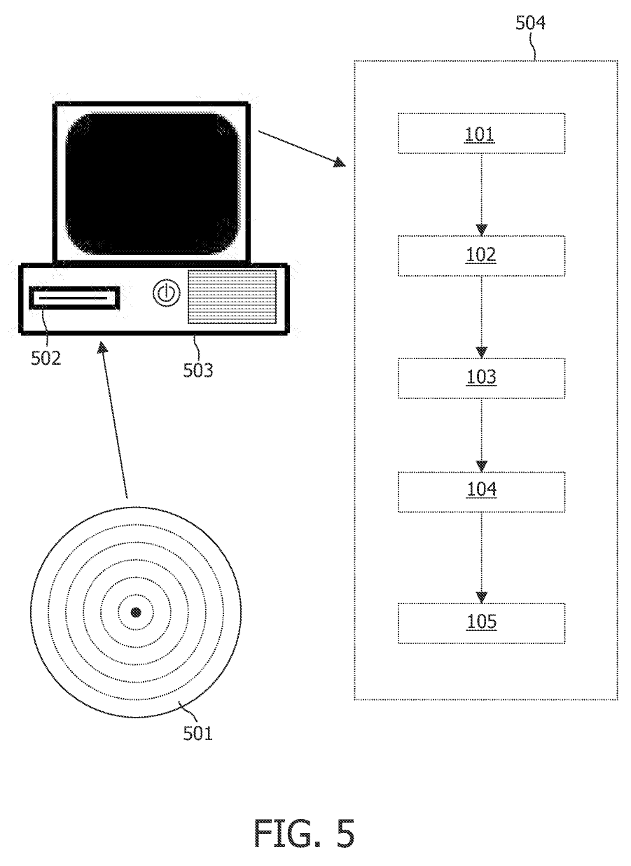

FIG. 5 schematically shows a medium containing a computer program for combining duplicative portions of magnetic resonance images to form a combined image.

It may be noted that corresponding reference numerals used in the various figures represent corresponding elements in the figures.

FIG. 1 illustrates a possible implementation of the disclosed method. In a step 101, a first value is computed based on pixel intensities in a first region R1 of a first MR image Im1 and a second region R2 of a second MR image Im2. In a step 102, a second value is computed based on pixel intensities in a third region R3 of the second MR image Im2. Values between the first value and the second value may be calculated by interpolating between the two values, as represented by step 103. Based on the interpolation of step 103, pixel intensities of a selected set of pixels of the second image Im2 are modified in a step 104, to yield a modified second image Im2′. The first image Im1 and the modified second image Im2′ are merged in a step 105, such that the first and second regions R1, R2 overlap, to form a duplex combined image. It may be noted that the phrase “MR image” is used to denote both two-dimensional image slices as well as three-dimensional image volumes.

To acquire an MR image, a subject is introduced into an examination space within an MR imaging system. An MR image is acquired by exciting a set of spins in the subject, acquiring a signal from the subject, and reconstructing an image of the subject based on the acquired signal. In the case of an elongate subject, for example, a human or animal patient, multiple slices of adjacent sections of the anatomy may be acquired in a particular orientation, for example, axial, sagittal, coronal, oblique, etc. These multiple slices are later fused together to form a three-dimensional volume representing the anatomy. From the fused volume, it is possible to generate slices or images in orientations other than the one in which the original slices were acquired. For example, coronal or sagittal slices may be generated from a volume image that was created by fusing multiple axial images. Such generated images are called reformatted images.

As the signal from the subject decays by T₁ and T₂ relaxation mechanisms during the acquisition process, and as there may be a time lag between collecting the first and the last slice, it is likely that the slices acquired later have reduced pixel intensity for the same tissue compared to a slice acquired earlier in time. When reformatted images are generated from an image volume formed by fusing such slices that have been acquired at different times, the gray levels or pixel intensities may appear to change from one end of the reformatted image to the other, for the same tissue. It was an insight of the inventors that T₁ and T₂ relaxation, when combined with certain reconstruction algorithms, could affect signal intensity of a tissue along the spatial axis representing the slice direction. Under such circumstances, when two reformatted images with duplicative regions are combined, it is possible that a tissue on one side of the border of the overlapping area in the combined image, formed by the duplicative regions, has a different pixel intensity compared to the same tissue on the other side of the border. The same phenomenon may also be observed in other situations where there is a time difference between imaging of different regions, for instance, in cases where multiple locations are imaged after a single excitation pulse sequence.

Typically, MR imaging systems have a certain maximum field-of-view (FOV), which determines the range or extent of the subject's anatomy that can be imaged in one scan. When the number of samples acquired is too small, i.e., when the k-space frequencies are not sampled densely enough, portions of the object outside of the desired FOV get mapped to an incorrect location inside the FOV. This is called aliasing, and could occur in any of the gradient directions, namely the slice encoding, phase encoding and frequency encoding directions. If images covering areas of the anatomy larger than that covered by the field-of-view are desired, separate images may be collected from different, preferably adjacent, portions of the anatomy, and fused or combined to generate a combined image. In order to collect these images, the subject is typically scanned in one region, then moved to an appropriate new position or station, and scanned again. Such a technique is sometimes referred to as “multi-station” scanning. Using this technique, it is possible to generate a combined image covering large portions of the anatomy. When the combined image covers the anatomy from head to toe, the imaging technique is sometimes referred to as “whole-body” imaging. Other names include “moving-bed imaging”, “COMBI or COmbined Moving Bed Imaging”, etc. Such images are useful in “bolus-tracking” studies for example, wherein the spread of an MR contrast agent injected into the blood in one part of the body, for example, the femoral vein, is tracked as it spreads through the blood vessels throughout the body.

The separate images collected from different anatomical regions of the patient may be combined to yield an image covering the area previously covered by the multiple images individually. Considering a case of two-dimensional images, for example, it is possible to make three scans separately of the abdomen, the upper legs (for example, from the pelvic region to the knees), and the lower legs (for example, from the knees to the toes), and later merge these individual scans into one image. The same principle could be extended to three-dimensional images, where for example, separate volumes of the head and of the neck could be merged to form a single image volume dataset.

One way of obtaining a three-dimensional volume image in MR imaging is to phase encode the spins along two axes, for example, the logical Y and Z axes (i.e., the phase encode and the slice select axes, respectively), before acquisition. In this case, reformatted images in any orientation may be obtained by suitably processing the volume image. Another way of obtaining three-dimensional images in MR imaging is to collect multiple slices of adjacent portions of the anatomy, and then combine the images to generate a volume image of the anatomy. It is also possible to obtain a volume image of a region of interest by using the multi-station scanning technique, by collecting multiple slices per station and fusing the multiple slices obtained from all the stations, to generate a volume image of the region of interest. The slices are typically collected in a particular orientation, for example, axial, sagittal or coronal. The series of slices so obtained are sometimes referred to a “stack” of slices, e.g., an axial “stack” or a “coronal” stack, etc. The volume image generated from a stack of slices may later be processed to obtain reformatted slices in an orientation different from the one in which the slices in the stack were originally collected.

Multi-station scanning in MR imaging is often performed with some overlap in space. This results in the same anatomical parts being represented in portions of different images. Such portions of different images that display substantially the same portion of the subject's anatomy are called duplicative portions of the MR images. For example, while scanning the upper and lower legs in a multi-station scanning scheme collecting axial slices, a volume image of the upper legs extending from the top of the pelvic region to below the patella may be acquired in the first station. In the second station, a volume image of the lower legs extending from the top of the patella to the toes may be acquired. Thus, in this case, the portions of the two different image volumes that represent the patellar region are the duplicative portions of the MR images. If necessary, the two image volumes may be registered using portions of the duplicative region, in this case the patellar region, as reference, and combined into a single image volume covering the upper and the lower legs. A reformatted image slice in any orientation may now be extracted from the combined image volume. Alternatively, reformatted coronal or sagittal image slices may be obtained directly from the two volume images separately, before the image volumes are combined. The reformatted image slices may now be combined according to the disclosed method to form a combined reformatted image slice.

The duplicative regions of the two MR images, for example, a first region R1 of a first MR image Im1 and a second region R2 of a second MR image Im2, may be compared in their entirety, especially when the entire first and second regions R1, R2 contain useful pixel data. However this may not necessarily be the case, for example in the case of reformatted slices, which may have black areas, i.e., areas in the image that predominantly contain pixels with a value of zero. In such cases, it is possible to compare only a portion, e.g. the middle portion, of each duplicative region. In the case of a human or an animal subject, since the duplicative regions likely represent the same anatomical part, the middle portions of the two duplicative regions likely comprise the same tissue being imaged. It is also possible to identify portions of the overlapping images that represent the same anatomical part, using some morphological operations as described in the next paragraph. For these identified portions, we may compare histograms, or derived statistics like mean or maximum values, etc., to compute a first value. It may be noted that the method would work more effectively if the portions chosen from the duplicative regions of the two images represent substantially the same part of the anatomy.

One possible method of finding a group of pixels that define a common area is to threshold the duplicative regions from both the images on value 1. This means all non-zero pixel values in the duplicative region will assume a binary 1 value and all others would assume a binary 0 value. Applying the procedure on the two MR images would yield two binary images. The common area may now be found by performing a morphological AND operation on the two binary images. The common area so determined may be used as a mask to select two sets of pixels from the two MR images. These two sets of pixels may now be compared, to derive the first value.

The second value may be obtained from a third region R3 of the second MR image Im2. The third region R3 may be disjoint with the second region R2. The second and third regions R2, R3 may be located on opposing ends of the second image Im2. Alternatively, the third region R3 may be located substantially towards the middle of the second image Im2. One way to select the third region R3 may be based on a tissue of interest. For example, if a particular blood vessel of interest extends from the second region R2 to a location within the second image Im2, then that location within the second image Im2 may be considered as the third region R3.

An average value of pixel intensities from the third region R3 may be used as the second value. Alternatively, the intensity value of the brightest pixel may be used as the second value. Other statistical measures, like median or mode, etc., may alternatively be used to compute the second value.

Correction values for regions in between the second region R2 and the third region R3 may be obtained by interpolating linearly between the first and second values. Thus, the correction values will show a trend based on the interpolation equation used, and each pixel or group of pixels along a line connecting the second and third regions R2, R3 may have a different correction value. Based on this interpolation, an inverse or reciprocal function, i.e. the function used to correct for the change in intensity, may be calculated. In the case of a linear interpolation equation, the inverse function is simply the equation satisfying a line having the opposite slope. For example, if the interpolation equation yields a line containing values from A to B, then the inverse function would be a line containing values from B to A, which would then be the correction factors. The inverse function, and consequently, the correction factors are continuous along the slice-select axis, and each point of the second image Im2, based on its position in the image, is multiplied with a different correction factor, along the axis connecting the second region R2 and the third region R3. Thus, based on the interpolation, the pixel intensities of all the pixels in the second image Im2 are modified. In this case, the selected set of pixels comprises all pixels in the second image Im2.

While linear interpolation requires only two points, other interpolation techniques may require additional data points for obtaining an accurate fit. For example, if a blood vessel running from the upper leg to the lower leg is being traced in overlapping MR images, then representative pixel intensity at various points along the length of the blood vessel in one or both of the images may be obtained, for example using an MIP operation. Fitting a curve to these representative pixel intensities would yield a possible interpolation function, including possibly higher-order interpolation functions. Considering the physics of MR acquisition, it is likely that the signal decays exponentially. Depending on the tissue, the signal decay could be mono-exponential or multi-exponential in nature. A corresponding inverse function may now be obtained based on the non-linear interpolation equation, for example by taking a reciprocal of the exponential decay curve.

It is also possible to apply the interpolation function, and extrapolate beyond the region from which the first or the second value was computed. For example, it is possible to compute a first value from the duplicative regions of the first and second images Im1, Im2, compute a second value from a region substantially towards the middle of the second image Im2, and interpolate between the first and second values. The interpolation function may now be extrapolated beyond the region of the second image Im2 from which the second value was computed, and correction factors obtained for the whole image.

Interpolation techniques that may be used include, but are not limited to, linear interpolation, exponential interpolation, bicubic interpolation, bilinear interpolation, trilinear interpolation, nearest-neighbor interpolation, etc.

FIG. 2 illustrates a possible implementation of the disclosed method. In a step 201, a first value is computed based on pixel intensities in a first region R1 of a first MR image Im1 and a second region R2 of a second MR image Im2. A second value is computed in step 202, based on pixel intensities in a third region R3 of the second MR image Im2 and a fourth region R4 of a third image Im3. Values in between the first value and the second value are calculated by interpolating between the first value and the second value, as represented by a step 203. Based on the interpolation of step 203, pixel intensities of the second image Im2 are modified in a step 204, to yield a modified second image Im2′. The first image Im1, the modified second image Im2′ and the third image Im3 are merged in a step 205, such that the first region R1 overlaps the second region R2, and the third region R3 overlaps the fourth region R4, to form a triplex combined image. Thus, in the case of three overlapping images, where the second image Im2 overlaps both the first and the third images Im1, Im3, the second value may be obtained from the duplicative regions R3, R4 of the second and third images Im2, Im3, respectively, by comparing pixel intensities of common areas, in a manner similar to obtaining the first value, as explained in the description of FIG. 1.

This aspect of the disclosed method combines a third MR image Im3 with the first and second images Im1, Im2, wherein the second value is computed additionally based on pixel intensities in a fourth region R4 of the third MR image Im3. A triplex combined image is then formed by additionally merging the modified second image Im2′ and the third image Im3 such that the third and the fourth regions R3, R4 overlap each other. Thus, by modifying the pixel intensities of one of the images, for example the second image Im2, a triplex combined image that is easier to interpret visually is formed.

In this case where more than two images are being merged together, the first value and the second value are computed at the two duplicative regions of the middle image. The first value is obtained by comparing pixel intensities in the duplicative portions of the first and second images Im1, Im2, namely the first and second regions R1, R2, respectively. Similarly, the second value is computed by comparing pixel intensities in the duplicative portions of the second and third images Im2, Im3, namely the third and fourth regions R3, R4, respectively. Correction values for regions in between the two duplicative regions of the middle image, in this case considered to be the second image Im2, may be obtained by interpolation between the first and second values. If we multiply the middle image Im2 with the inverse or reciprocal of the correction values, it results in a smoother transition in pixel intensities for the same type of tissue. The correction values are continuous along the slice axis, and each point of the middle image is multiplied with a different reciprocal correction value, based on the point's position in the image, along the axis connecting the two duplicative regions of the middle image. When the three images, i.e., the first image Im1, the modified second image Im2′, and the third image Im3, are combined by overlapping the first and the second regions R1, R2, and also overlapping the third and fourth regions, R3, R4, anatomical structures e.g. blood vessels, that continue across two or more images will have a more similar intensity. This will enable automatic segmentation procedures to perform better on the new reconstructed volume.

Alternative to modifying the intensity values of all the pixels in the second image Im2 as explained in the description of FIG. 1, it is possible to modify pixel intensities of a more restricted selected set of pixels. For example, in a three-dimensional contrast-enhanced MR angiography image, the blood vessels containing the contrast agent usually have the brightest pixel intensities. By performing a maximum intensity projection (MIP) operation, it is possible to extract information about these blood vessels. If we consider three overlapping reformatted MR angiography images, the first value is computed based on the pixel intensities of blood vessels in the duplicative region between the first and the second images Im1, Im2, and the second value is computed based on the pixel intensities of blood vessels in the duplicative region between the second and the third images Im2, Im3. A MIP operation is performed on the second image Im2 to segment the blood vessels carrying the contrast agent. The correction factors, calculated by interpolating between the first and the second values and inverting the intermediate values, may now be applied only to those pixels identified by the MIP operation. This would give a smooth transition of only the identified blood vessels by modifying pixel intensities along their path, while leaving the rest of the image unaffected. It is possible to use operations other than an MIP operation, for example, segmentation techniques like region-growing algorithms, to extract information about a region of interest in the second image.

FIG. 3 illustrates a possible implementation of the disclosed method. In a step 301, a first value is computed based on pixel intensities in a first region R1 of a first MR image Im1 and a second region R2 of a second MR image Im2. In a step 302, a second value is computed based on pixel intensities in a third region R3 of the second MR image Im2. Values between the first value and the second value are calculated by interpolating between the first value and the second value, as represented by step 303. Based on the interpolation of step 303, pixel intensities of both the first image Im1 and the second image Im2 are modified, to yield modified first and second images Im1′, Im2′, in steps 304 and 305, respectively. The modified first and second images Im1′, Im2′ are merged in a step 306, such that the first and second regions R1, R2 overlap, to form the combined image.

This implementation of the disclosed method additionally modifies pixel intensity values of the first MR image Im1 based on the interpolation between the first value and the second value. This could further reduce differences in pixel intensities of the same tissue in the two images, and yield a combined image that is easier to interpret visually.

One way of achieving an advantageous result is to apply the correction factors obtained by interpolating between the first and second values, to both the first and the second images Im1, Im2. For example, from the interpolated values, an approximate middle point value may be identified between the first and second values. In the case of a linear interpolation function, this middle point value is likely to occur at a location approximately towards the middle of the second and third regions R2, R3 of the second image Im2. If the middle point value is normalized to 1, this location on the image may be called the “zero-rotation point”, since multiplication of the pixel intensity at this location with the normalized correction factor will not change the pixel intensities at that region. Regions to one side of the zero-rotation point become darker (0<correction factor<1) and regions to the opposite side of the zero-rotation point become brighter (correction factor>1). If a non-linear interpolation function is used, for example, an exponential decay function, then instead of the middle point value, some other appropriate value, for example, 38% of the difference between the first and the second values, may be used as the value at the zero-rotation point. Alternatively, the location of the zero-rotation point may be adjusted such that it corresponds to a value that is midway between the first and second values.

It may be noted that this implementation of the disclosed method may also be applied to a case where three or more MR images need to be combined.

FIG. 4 shows a possible embodiment of an MR system capable of combining duplicative portions of MR images to form a combined image. The MR system comprises an image acquisition system 480, and an image processing and display system 490. The image acquisition system 480 comprises a set of main coils 401, multiple gradient coils 402 connected to a gradient driver unit 406, and RF coils 403 connected to an RF coil driver unit 407. The function of the RF coils 403, which may be integrated into the magnet in the form of a body coil, or may be separate surface coils, is further controlled by a transmit/receive (T/R) switch 413. The multiple gradient coils 402 and the RF coils are powered by a power supply unit 412. A transport system 404, for example a patient table, is used to position a subject 405, for example a patient, within the MR imaging system. A control unit 408 controls the RF coils 403 and the gradient coils 402. The image reconstruction and display system 490 comprises the control unit 408 that further controls the operation of a reconstruction unit 409. The control unit 408 also controls a display unit 410, for example a monitor screen or a projector, a data storage unit 415, and a user input interface unit 411, for example, a keyboard, a mouse, a trackball, etc.

The main coils 401 generate a steady and uniform static magnetic field, for example, of field strength 1.5 T or 3 T. The disclosed methods are applicable to other field strengths as well. The main coils 401 are arranged in such a way that they typically enclose a tunnel-shaped examination space, into which the subject 405 may be introduced. Another common configuration comprises opposing pole faces with an air gap in between them into which the subject 405 may be introduced by using the transport system 404. To enable MR imaging, temporally variable magnetic field gradients superimposed on the static magnetic field are generated by the multiple gradient coils 402 in response to currents supplied by the gradient driver unit 406. The power supply unit 412, fitted with electronic gradient amplification circuits, supplies currents to the multiple gradient coils 402, as a result of which gradient pulses (also called gradient pulse waveforms) are generated. The control unit 408 controls the characteristics of the currents, notably their strengths, durations and directions, flowing through the gradient coils to create the appropriate gradient waveforms. The RF coils 403 generate RF excitation pulses in the subject 405 and receive MR signals generated by the subject 405 in response to the RF excitation pulses. The RF coil driver unit 407 supplies current to the RF coil 403 to transmit the RF excitation pulse, and amplifies the MR signals received by the RF coil 403. The transmitting and receiving functions of the RF coil 403 or set of RF coils are controlled by the control unit 408 via the T/R switch 413. The T/R switch 413 is provided with electronic circuitry that switches the RF coil 403 between transmit and receive modes, and protects the RF coil 403 and other associated electronic circuitry against breakthrough or other overloads, etc. The characteristics of the transmitted RF excitation pulses, notably their strength and duration, are controlled by the control unit 408.

It is to be noted that though the transmitting and receiving coil are shown as one unit in this embodiment, it is also possible to have separate coils for transmission and reception, respectively. It is further possible to have multiple RF coils 403 for transmitting or receiving or both. The RF coils 403 may be integrated into the magnet in the form of a body coil, or may be separate surface coils. They may have different geometries, for example, a birdcage configuration or a simple loop configuration, etc. The control unit 408 is preferably in the form of a computer that includes a processor, for example a microprocessor. The control unit 408 controls, via the T/R switch 413, the application of RF pulse excitations and the reception of MR signals comprising echoes, free induction decays, etc. User input interface devices 411 like a keyboard, mouse, touch-sensitive screen, trackball, etc., enable an operator to interact with the MR system.

The MR signal received with the RF coils 403 contains the actual information concerning the local spin densities in a region of interest of the subject 405 being imaged. The received signals are reconstructed by the reconstruction unit 409, and displayed on the display unit 410 as an MR image or an MR spectrum. It is alternatively possible to store the signal from the reconstruction unit 409 in a storage unit 415, while awaiting further processing. The reconstruction unit 409 is constructed advantageously as a digital image-processing unit that is programmed to derive the MR signals received from the RF coils 403.

FIG. 5 shows a possible embodiment of a medium 501 containing a computer program for combining duplicative portions of magnetic resonance images to form a combined image. The computer program is transferred to the computer 503 via a transfer means 502. The computer program contains instructions that enable the computer to perform the steps of the disclosed method 504.

The computer 503 is capable of loading and running a computer program comprising instructions that, when executed on the computer, enables the computer to execute the various aspects of the method 504 disclosed herein. The computer program may reside on a computer readable medium 501, for example a CD-ROM, a DVD, a floppy disk, a memory stick, a magnetic tape, or any other tangible medium that is readable by the computer 503. The computer program may also be a downloadable program that is downloaded, or otherwise transferred to the computer, for example via the Internet. The transfer means 502 may be an optical drive, a magnetic tape drive, a floppy drive, a USB or other computer port, an Ethernet port, etc.

Applications of the disclosed method include interventional procedures that necessitate a comparison of two or more images to perform an intervention, for example inserting a catheter into the femoral artery. Usually, radiologists prefer to pick an entry point that is close to the femoral head. An appropriate entry point is often decided by comparing two images, for example a frontal artery MIP image and a frontal bone slab MIP image. This comparison gives an approximate location of the stenosis related to the femoral head, which is used to decide the entry point. The method disclosed herein could be used in order to estimate the location of the stenosis more accurately.

A first combined image is formed as a duplex or a triplex image, using the disclosed method. The first combined image may be formed from reformatted images that in turn, have been obtained by processing an image volume created from a stack of contrast-enhanced images acquired in a particular orientation. The first combined image is thus a contrast-enhanced combined image. Similarly, a second combined image is formed as a duplex or a triplex image, using the disclosed method. The second combined image is a non-enhanced combined image, and may also be formed from reformatted images that in turn, have been obtained by processing an image volume created from a stack of non-contrast enhanced images acquired in a particular orientation. It may be noted that the above technique may also be extended to a three-dimensional dataset, wherein a first combined volume is formed from contrast-enhanced slices using the disclosed method, and a second combined volume is formed from non-enhanced slices using the disclosed method. Reformatted slices of the same portion of anatomy are extracted from each of the combined volumes, and superimposed on each other. Merge weights are assigned to each of the combined volumes or to the extracted reformatted slices, and the two reformatted slices are merged based on their respective merge weights, as explained earlier. By adjusting the merge weights of the two reformatted slices, one or the other of the two superimposed images could be visualized more prominently.

In one possible implementation, the non-enhanced combined image would primarily show bone and other tissue, while the contrast enhanced combined image would show arteries as well. If the former is subtracted pixel by pixel from the latter, the resulting subtracted image would primarily show the arterial tree. This is the known magnetic resonance digital subtraction angiography or MRDSA technique. Superimposing the subtracted image on the non-enhanced combined image would clearly indicate the position of the stenosis in the arterial tree relative to the femoral head. Different merge weights may be assigned to the two superimposed combined images. By adjusting the respective merge weights of the two superimposed combined images, it is possible to adjust the transparency of each of the superimposed images such that one or the other of the two superimposed images is visualized more prominently. It is assumed that the two combined images show the same portion of the anatomy, and that they have been properly registered. Otherwise, an additional step of registering the subtracted and the non-enhanced combined image, or alternatively, registering the contrast enhanced combined image and the non-enhanced combined image, would be required.

As mentioned earlier, merge weights may be assigned to each of the two superimposed images, and in one possible implementation, the merge weights may be varied between 0 and 1. Setting the merge weight of a particular image to 0 would make it invisible, while setting it to 1 would make the image fully visible. In other words, adjusting the merge weight of a particular image, between 0 and 1, makes it more transparent or more opaque, respectively. The adjustment of the merge weights may be performed using an appropriate user interface like virtual sliders, knobs, or a text box capable of accepting typed values between 0 and 1. The merge weights of the two superimposed images may be coupled in that if the merge weight of the subtracted image is set to a value X, the merge weight of the non-enhanced combined image would be automatically set to 1−X.

The order in the described embodiments of the disclosed methods is not mandatory. A person skilled in the art may change the order of steps or perform steps concurrently using threading models, multi-processor systems or multiple processes without departing from the disclosed concepts.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The disclosed method can be implemented by means of hardware comprising several distinct elements, and by means of a suitably programmed computer. In the system claims enumerating several means, several of these means can be embodied by one and the same item of computer readable software or hardware. The mere fact that certain measures are recited in mutually different dependent claims does not indicate that a combination of these measures cannot be used to advantage.

The words first, second etc., in the claims denote labels, and not an order or rank.

1. A method of combining duplicative portions of magnetic resonance images to form a combined image, the method comprising:
(a) computing a first value based on pixel intensities in a first region of a first magnetic resonance image and pixel intensities in a second region of a second magnetic resonance image;
(b) computing a second value based on pixel intensities in a third region of the second magnetic resonance image;
(c) modifying original intensity values of a selected set of pixels of the second magnetic resonance image based on an interpolation between the first value and the second value, to yield a modified second image; and
(d) forming a first duplex combined image by merging the first magnetic resonance image with the modified second image such that the first and second regions overlap each other.

2. The method of claim 1, wherein computing the second value is also based on pixel intensities in a fourth region of a third magnetic resonance image, and wherein the method comprises:
(e) forming a first triplex combined image by merging the first duplex combined image with the third magnetic resonance image such that the third and the fourth regions overlap each other.

3. The method of claim 1 comprising modifying original intensity values of a selected set of pixels of the first magnetic resonance image based on the interpolation between the first value and the second value.

4. The method of claim 1, comprising:
repeating steps (a) to (d) of claim 1 to yield a second duplex combined image;
assigning respective merge weights to each of the first and the second duplex combined images; and
merging the first duplex combined image with the second duplex combined image based on their respective assigned merge weights, to yield a first composite image.

5. The method of claim 2, comprising:
repeating step (e) of claim 2 to yield a second triplex combined image;
assigning respective merge weights to each of the first and the second triplex combined images; and
merging the first triplex combined image with the second triplex combined image based on their respective assigned merge weights, to yield a second composite image.

6. The method of claim 1, comprising:
repeating steps (a) to (d) of claim 1 to yield a third duplex combined image;
subtracting the first duplex combined image from the third duplex combined image to yield a first subtracted image;
assigning respective merge weights to each of the first duplex combined image and the first subtracted image; and
merging the first duplex combined image with the first subtracted image based on their respective assigned merge weights, to yield a third composite image.

7. The method of claim 2, comprising:
repeating step (e) of claim 2 to yield a third triplex combined image;
subtracting the first triplex combined image from the third triplex combined image to yield a second subtracted image;
assigning respective merge weights to each of the first triplex combined image and the second subtracted image, and
merging the first triplex combined image with the second subtracted image based on their respective assigned merge weights, to yield a fourth composite image.

8. The method of claim 1 wherein the magnetic resonance images are reformatted images, formed by
collecting multiple slices in a particular orientation, each slice representing an adjacent portion of anatomy,
fusing the multiple slices to generate an image volume, and
processing the image volume to obtain slices in an orientation different from the particular orientation.

9. The method of claim 1 wherein modifying original intensity values of a selected set of pixels of the second magnetic resonance image includes
deriving correction values based on the interpolation, and
multiplying each pixel of the second image with a different correction value based on the pixel's position in the second image.

10. A magnetic resonance system comprising:
an image acquisition system; and
an image processing and display system;
wherein the image processing and display system is configured to combine duplicative portions of magnetic resonance images to form a combined image by:
(a) computing a first value based on pixel intensities in a first region of a first magnetic resonance image and pixel intensities in a second region of a second magnetic resonance image;
(b) computing a second value based on pixel intensities in a third region of the second magnetic resonance image;
(c) modifying original intensity values of a selected set of pixels of the second magnetic resonance image based on an interpolation between the first value and the second value, to yield a modified second image; and
(d) forming a first duplex combined image by merging the first magnetic resonance image with the modified second image such that the first and second regions overlap each other.

11. A computer program for combining duplicative portions of magnetic resonance images to form a combined image, the computer program comprising instructions for:
(a) computing a first value based on pixel intensities in a first region of a first magnetic resonance image and pixel intensities in a second region of a second magnetic resonance image;
(b) computing a second value based on pixel intensities in a third region of the second magnetic resonance image;
(c) modifying original intensity values of a selected set of pixels of the second magnetic resonance image based on an interpolation between the first value and the second value, to yield a modified second image; and
(d) forming a first duplex combined image by merging the first magnetic resonance image with the modified second image such that the first and second regions overlap each other.
